(19) United States
(12) Patent Application Publication
(10) Pub. No.: US 2010/0053432 A1
(43) Pub. Date: Mar. 4, 2010

(54) DIGITAL PHOTO FRAME WITH TELEVISION TUNING FUNCTION AND METHOD THEREOF

(75) Inventors: Chia-Yu Cheng, Tu-Cheng (TW); Yun Xiao, Shenzhen City (CN); Li-Hua Hu, Shenzhen City (CN); Zai-An Pan, Shenzhen City (CN); Kuan-Hong Hsieh, Tu-Cheng (TW); Han-Che Wang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/412,378

(22) Filed: Mar. 27, 2009

(30) Foreign Application Priority Data
Aug. 28, 2008 (CN) 200810304258.5

(51) Int. Cl. H04N 7/00; H04N 3/27

(52) U.S. Cl. 348/552; 348/554; 348/E07.001; 348/E03.049

(57) ABSTRACT

A method of a digital photo frame (DPF) with television (TV) tuning function is provided. The method includes: creating one or more preview windows on the DPF under the DPF mode; receiving broadcasts of particular channels; displaying the broadcast contents of the particular channels in each of the preview windows; switching the DPF to a TV mode if a mode switching signal is received within the display of the broadcast contents of the particular channels; determining which of favorite channels currently previewed in the preview windows is selected; and receiving and playing broadcasts of the selected particular channel. A related DPF is also provided.

### BACKGROUND

1. Technical Field

The present disclosure relates to a digital photo frame (DPF) capable of television (TV) tuning function and method thereof.

2. Description of Related Art

Along with rapid development in electronic technology, DPFs have become familiar to consumers. Some types of DPFs have been designed to not only display photos, but also receive television (TV) programs.

A DPF is usually in a DPF mode of the DPF to display photos or the like. However, conventional DPFs do not provide a TV program preview function while in the DPF mode. So when the DPF is in the DPF mode, people cannot conveniently know what TV programs are on which would be useful for people when they forget the broadcast times of their favorite TV programs. Additionally, it may not be convenient for people to manually switch the DPF from the DPF mode to a TV mode frequently, to check if their program has started yet.

### BRIEF DESCRIPTION OF THE DRAWINGS

The components of the drawings are not necessarily drawn to scale, the emphasis instead being placed upon clearly illustrating the principles of a digital photo frame (DPF) with television (TV) tuning function and method thereof. Moreover, in the drawings, like reference numerals designate corresponding parts throughout several views.

FIG. 1 is a front view of a DPF with television (TV) tuning function in accordance with an exemplary embodiment.

FIG. 2 is a block diagram of the DPF of FIG. 1 in accordance with an exemplary embodiment.

FIG. 3 is a schematic view showing preview windows created on the DPF of FIG. 1 in accordance with an exemplary embodiment.

FIG. 4 is a flowchart for illustrating a TV tuning method of the DPF of FIG. 1 in accordance with an exemplary embodiment.

### DETAILED DESCRIPTION OF THE EMBODIMENTS

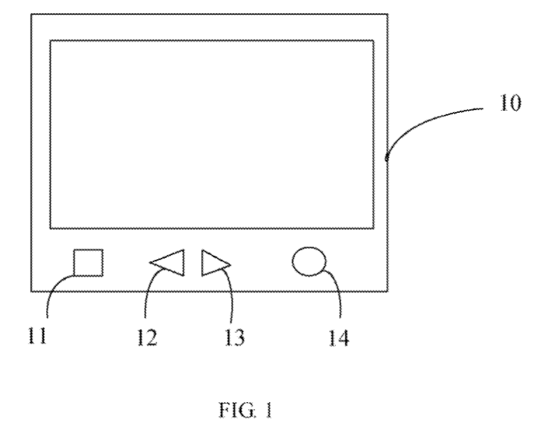

FIG. 1 is a front view of a DPF 10 with television (TV) tuning function in accordance with an exemplary embodiment.

The DPF 10 mainly includes a power button 11, a previous button 12, a next button 13, and a switch button 14. The power button 11 is configured for powering on and powering off the DPF 10. The switch button 14 is configured for manually switching between operation modes of the DPF 10, for example, between a DPF mode and a TV mode. When the DPF 10 is in the DPF mode, the previous button 12 and the next button 13 are configured for paging through multimedia files such as photos stored in the DPF 10. When the DPF 10 is in the TV mode, the previous button 12 and the next button 13 are configured for changing TV channels.

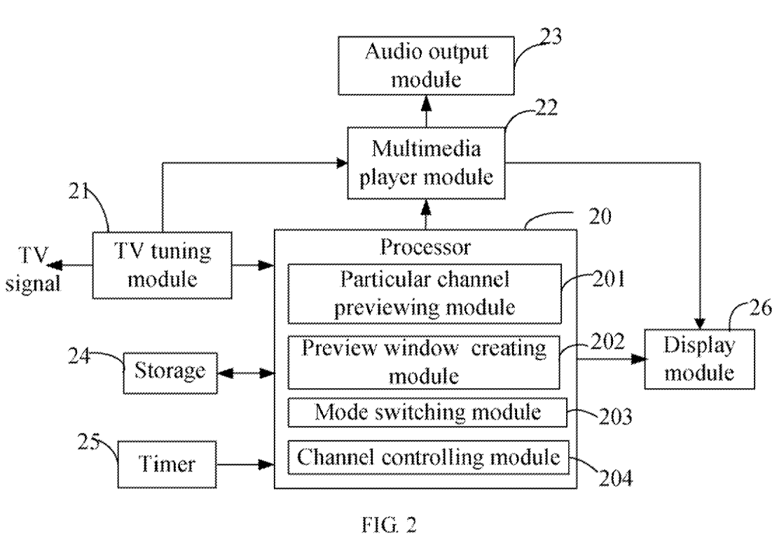

FIG. 2 is a block diagram of the DPF 10 in accordance with an exemplary embodiment.

The DPF 10 includes a processor 20 connected to a TV tuning module 21, a multimedia player module 22, a storage 24 and a display module 26, which are controlled by the processor 20.

The storage 24 is configured for storing multimedia files. The multimedia files may include image files, audio files, video files, and so on. When the DPF 10 is in the DPF mode, the processor 20 fetches the multimedia files from the storage 24 and transfers the multimedia files to the multimedia player module 22. The multimedia player module 22 then reproduces image/video/audio data of the multimedia files. When the DPF 10 is in the TV mode, the TV tuning module 21 is controlled by the processor 20 to receive broadcasts of TV channels and transfers contents of the broadcasts to the multimedia player module 22. The multimedia player module 22 then reproduces image/video/audio data of the contents of the broadcasts on the display module 26. The multimedia player module 22 is connected to an audio output module 23 (e.g., a speaker) and the display module 26. The audio output module 23 is configured to output audio data of the multimedia files and the contents of the broadcasts, and the display module 26 is configured to output the image/video data of the multimedia files and the contents of the broadcasts.

The storage 24 is further configured for storing one or more channel parameters of particular channels in which users are interested, for example, those favored by the users, and preview window parameters. The particular channel parameters can be channel numbers or channel frequencies. The preview window parameters are configured for defining one or more preview windows on the display module 26 to preview contents of the particular channels. In this embodiment, the preview window parameters include a parameter defining the number of the preview windows and the parameters defining the location of each of the preview windows on the display module 26. Furthermore, the particular channel parameters and the preview window parameters can be preset and changed by the users through a combination of the previous button 12, the next button 13, and one or more other buttons.

The DPF 10 further includes a timer 25. The timer 25 can have a default setting or a user-selected setting. The timer 25 may count-up or count-down.

The processor 20 includes a particular channel previewing module 201, a preview window creating module 202, a mode switching module 203, and a channel controlling module 204.

The particular channel previewing module 201 is configured for controlling previewing of currently aired programs of the particular channels, including providing the preview window parameters to the preview window creating module 202, providing the particular channel parameters one after another to the channel controlling module 204 according to a preset order, controlling the display of the broadcast contents of the particular channels, and controlling a preview time of the currently aired programs of the particular channels by employing the timer 25 to time the preview time.

The preview window creating module 202 is configured for creating one or more preview windows on the display module 26 according to the preview window parameters. In this embodiment, the preview windows are of uniform size and shape. On one hand, currently aired programs of the particular channels are displayed within the preview windows. Viewable content of currently open multimedia files is displayed outside the preview windows. On the other hand, during the preview, a particular channel in a preview window can be directly selected by users to play under the TV mode if the switch button 14 is operated to transmit a mode switching signal to the mode switching module 203.

The mode switching module 203 is configured for switching operation modes between the DPF mode and the TV mode upon receiving a mode switching signal transmitted from the switch button 14, and further configured for determining which of the particular channels currently previewed in the preview windows is selected to broadcast and providing the particular channel parameter of the selected particular channel to the channel controlling module 204.

The channel controlling module 204 is configured for controlling the TV tuning module 21 to receive broadcasts of the selected particular channel.

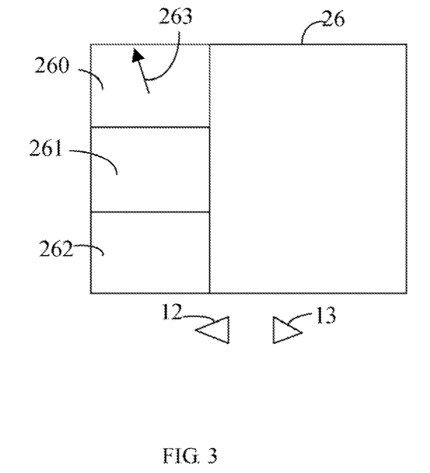

FIG. 3 is a schematic view showing preview windows created on the DPF of FIG. 1 in accordance with an exemplary embodiment.

The preview window creating module 202 creates three preview windows on the left region of the display module 26, respectively referred as the first preview window 260, the second preview window 261, and the third preview window 262. A cursor 263 appears and points to the first preview window 261 during the preview of the broadcast contents of the particular channels. The cursor 263 can be moved to any one of the preview windows by using the previous button 12 and the next button 13.

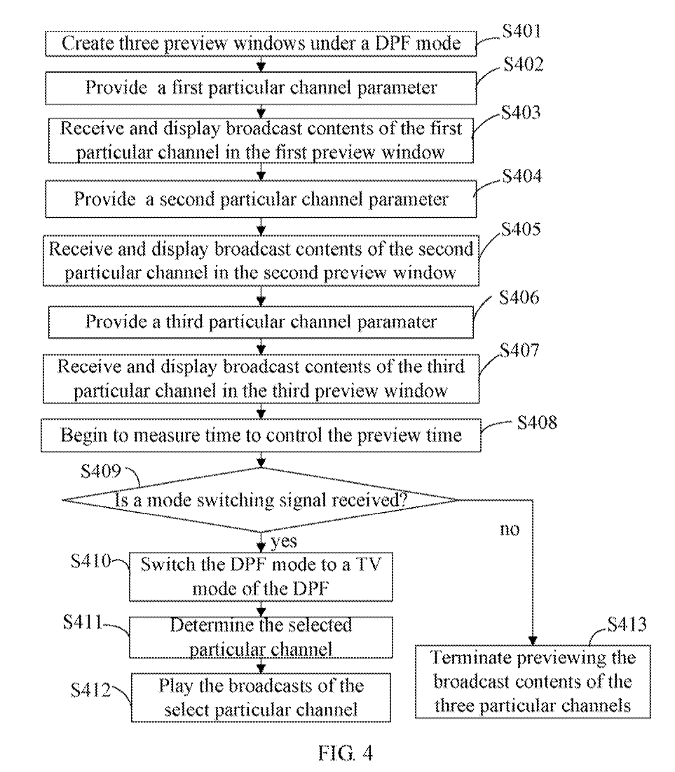

FIG. 4 is a flowchart for illustrating a TV tuning method of the DPF 10 in accordance with an exemplary embodiment.

In step S401, under the DPF mode, the particular channel previewing module 201 provides the preview window parameters to the preview window creating module 202, thereby the preview window creating module 202 creates at least one preview window on the display module 26 according to the preview window parameters. In the exemplary embodiment, the preview window creating module 202 creates three preview windows on the left region of the display module 26 (see FIG. 3).

In step S402, the particular channel previewing module 201 provides a first particular channel parameter stored in the storage 24 to the channel controlling module 204 according to a preset order.

In step S403, the channel controlling module 204 controls the TV tuning module 21 to receive broadcasts of the first particular channel. The particular channel previewing module 201 then displays the broadcast contents of the first particular channel in the first preview window 260 via the multimedia player module 22.

In step S404, upon receiving several frames of the broadcast contents of the first particular channel, the particular channel previewing module 201 provides a second particular channel parameter to the channel controlling module 204 according to the preset order.

In step S405, the channel controlling module 202 controls the TV tuning module 21 to receive broadcasts of the second particular channel. The particular channel previewing module 201 then displays the broadcast contents of the second particular channel in the second preview window 401 via the multimedia player module 22. The received final frame of the broadcast contents of the first particular channel is displayed in the first preview window 260 as a static image.

In step S406, upon receiving several frames of the broadcast contents of the second particular channel, the particular channel previewing module 201 provides a third particular channel parameter to the channel controlling module 204 according to the preset order.

In step S407, the channel controlling module 204 controls the TV tuning module 21 to receive broadcast contents of the third particular channel. The particular channel previewing module 201 then displays the broadcast contents of the third particular channel in the third preview window 262 via the multimedia player module 22. The received last frame of broadcast contents of the second particular channel is displayed in the second preview window 261 as a static image.

In step S408, the particular channel previewing module starts the timer 25 to control the preview time of previewing the received broadcast contents of the three particular channels.

In step S409, during the preview, the mode switching module 203 determines whether a mode switching signal is received. If yes, the procedure forwards to step S410, otherwise the procedure forwards to step S413.

In step S410, the mode switching module 203 changes operation mode of the DPF 10 from the DPF mode to the TV mode.

In another exemplary embodiment, before switching the DPF 10 to the TV mode, the settings and progress of playing the multimedia files under the DPF mode are automatically stored in the storage 24 by the processor 20, such that the DPF 10 will resume the stored settings and progress of playing the multimedia files when returning to the DPF mode from the TV mode.

In step S411, the mode switching module 203 determines which of particular channels currently previewed in the preview windows is selected to play and provides the channel parameter of the selected particular channel to the channel controlling module 204. In the exemplary embodiment, referring to FIG. 3, if the users move the cursor 263 to a preview window and operates the switch button 14 to transmit a mode switching signal to the mode switching module 203, this means a particular channel in the preview window is selected by the users to play and the channel parameter of the particular channel is determined by the mode switching module 203.

In step S412, the channel controlling module 204 controls the TV tuning module 21 to receive broadcasts of the selected particular channel.

In step S413, upon expiration of the preview time, the particular channel previewing module 201 terminates displaying the received broadcast contents of the three favorite channels on the display module 26 via the multimedia player module 22.

Generally, the particular channel previewing module 201 activates the preview of broadcast contents of the particular channels under the DPF mode every preset time value. The preset time value is an execution period of the whole procedure. In the exemplary embodiment, if particular channel parameters of more than three favorite channels are pre-stored in the storage 24, the particular channel previewing module 201 provides the particular channel parameters of the particular channels which are immediately following the first three particular channels according to the preset order to the channel controlling module 204, and controls the preview of the particular channels during the next execution period. As such, all particular channels are previewed in one or more prosecution periods and each of them can be selected to broadcast during its preview.

In an alternative embodiment, if particular channel parameters of more than three particular channels are pre-stored in the storage 24, all of particular channels are previewed in the same execution period. One or more steps are added between steps S407 and S408. In those steps particular channel parameters of following particular channels are provided to the channel controlling module 204 in turn according to the preset order and the contents of the following particular channels are previewed in the three preview windows. Each of the following particular channels can also be selected to broadcast when it is previewed in one of the preview windows.

Although the present disclosure has been specifically described on the basis of preferred embodiments and method thereof, the disclosure is not to be construed as being limited thereto. Various changes or modifications may be made to the embodiments without departing from the scope and spirit of the invention.

What is claimed is:

1. A digital photo frame (DPF) with television (TV) tuning function comprising a DPF mode and a TV mode, comprising:
a display module;
a TV tuning module configured for receiving broadcasts of TV channels;
a processor comprising:
a preview window creating module configured for creating one or more preview windows on the display module under the DPF mode, wherein each of the preview windows is configured for displaying broadcast contents of a particular channel;
a particular channel previewing module configured for controlling preview of broadcast contents of one or more particular channels in the preview windows;
a mode switching module configured for changing operation mode of the DPF to the TV mode if a mode switching signal is received within the preview of the broadcast contents of particular channels, and further determining which of the particular channels currently previewed in the preview windows is selected to play and providing particular channel parameter of the selected particular channel to a channel controlling module; and
the channel controlling module configured for controlling the TV tuning module to receive broadcasts of the selected particular channel under the TV mode.

2. The DPF as described in claim 1, further comprising a storage accessible and controllable by the processor, wherein the storage is configured for storing particular channel parameters of the particular channels and preview window parameters of the preview windows, wherein the preview window parameters comprise a parameter defining number of preview windows and parameters defining preview locations of the preview windows on the display module.

3. The DPF as described in claim 2, wherein the preview window creating module being configured for creating one or more preview windows on the display module comprises the preview window creating module being configured for creating the preview windows according to the preview window parameters.

4. The DPF as described in claim 1, wherein the particular channel previewing module being configured for controlling the preview of the broadcast contents of the particular channels comprises the particular channel previewing module being configured for providing the particular channel parameters to the channel controlling module, allocating the preview windows for the particular channels and controlling a preview time of the particular channels.

5. The DPF as described in claim 4, wherein the particular channel previewing module being configured for controlling the preview of the broadcast contents of the particular channels comprises the particular channel previewing module being configured for activating the previewing of broadcast contents of the particular channels every preset time interval.

6. The DPF as described in claim 5, wherein the particular channel previewing module being configured for controlling the preview of the particular channels comprises the particular channel previewing module being configured for providing the particular channel parameters of all the particular channels to the channel controlling module in each preset time interval.

7. The DPF as described in claim 5, wherein the particular channel previewing module being configured for controlling the preview of the particular channels comprises the particular channel previewing module being configured for providing the particular channel parameters of a preset number of particular channels in each preset time interval.

8. The DPF as described in claim 4, wherein the particular channel previewing module being configured for controlling the preview of the broadcast contents of the particular channels comprises the particular channel previewing module being configured for starting a timer to time the preview time of previewing the broadcast contents of the particular channels and terminating the preview of the broadcast contents of the particular channels when the preview time timed by the timer reaches a preset time value.

9. The DPF as described in claim 1, further comprising a previous button and a next button configured for users to move a cursor on the display module to select one of the particular channels currently previewed in the preview windows to play.

10. The DPF as described in claim 1, wherein the preview windows are of uniform size and shape.

11. The DPF as described in claim 1, wherein the processor is further configured for automatically storing current settings under the DPF mode in the storage before the DPF is switched from the DPF mode to the TV mode.

12. A method of a digital photo frame (DPF) with television (TV) tuning function comprising a DPF mode and a TV mode, comprising:
creating one or more preview windows on the DPF under the DPF mode;
receiving broadcasts of particular channels;
displaying the broadcast contents of the particular channels in each of the preview windows;
determining whether a mode switching signal is received within the preview of the broadcast contents of the particular channels;
changing operation mode of the DPF from the DPF mode to the TV mode if a mode switching signal is received;
determining which of the particular channels currently previewed in the preview windows is selected to play; and
receiving and playing broadcasts of the selected particular channel.

13. The method as described in claim 12, wherein the preview windows are of uniform size and shape.

14. The method as described in claim 12, further comprising moving a cursor on the DPF to select one of the particular channels currently previewed in the preview windows to play.

15. The method as described in claim 12, further comprising:
automatically storing current settings under the DPF mode before switching the DPF from the DPF mode to the TV mode
